(19) United States
(12) Patent Application Publication
(10) Pub. No.: US 2007/0258588 A1
(43) Pub. Date: Nov. 8, 2007

(54) INFORMATION PROCESSING APPARATUS, INFORMATION PROCESSING METHOD, AND PROGRAM

(75) Inventor: Ichiro OGATA, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/739,487

(22) Filed: Apr. 24, 2007

(30) Foreign Application Priority Data
May 1, 2006 (JP) 2006-127662

(51) Int. Cl. H04N 7/167

(52) U.S. Cl. 380/201

(57) ABSTRACT

Disclosed herein is an information processing apparatus for converting a first signal furnished as an input baseband video signal into a second signal to be output. The information processing apparatus includes: a conversion unit configured to convert the first signal into the second signal of a predetermined system; a delay unit configured to delay the first signal to ensure synchronism with the second signal following the conversion; and a selection unit configured to select either the delayed first signal or the second signal in accordance with a third signal. The selection unit outputs either the delayed first signal or the second signal that has been selected.

### CROSS REFERENCES TO RELATED APPLICATIONS

The present invention contains subject matter related to Japanese Patent Application JP 2006-127662 filed with the Japan Patent Office on May 1, 2006, the entire contents of which being incorporated herein by reference.

### BACKGROUND OF THE INVENTION

1. Field of the Invention

The present invention relates to an information processing apparatus, an information processing method, and a program. More particularly, the invention relates to an information processing apparatus, an information processing method, and a program for identifiably displaying part of an image representative of converted image data.

2. Description of the Related Art

FIG. 1 is a block diagram showing a typical structure of a system 1 made up of an ordinary encryption apparatus 11 and an ordinary decryption apparatus 12 (called the encryption and decryption system 1 hereunder). In FIG. 1, the rectangles with solid lines represent component blocks of the system and the rectangles with dotted lines denote items of information. The selective uses of solid and dotted lines to represent the different kinds of entities will also apply to some of the drawings to be discussed below.

In an encryption unit 21, an AES encryption data generation unit 31 generates AES (Advanced Encryption Standard) encryption data 65 for encrypting stream data (called AV (audio visual) data hereunder) representative of images in frames, using two kinds of data: an LE key 61E (common key) for AV data encryption, and an AES input 62E. It is assumed that AV data is HD-SDI (High Definition Serial Digital Interface) data constituted by at least one frame.

A P-P (parallel-parallel) conversion unit 32 and stream conversion units 33a and 33b turn the AES encryption data 65 into two kinds of AES encryption data 65a and 65b. The AES encryption data 65a is supplied to a luminance data encryption unit 34a for encrypting data Y indicative of the luminance of each of the pixels making up the frames of AV data. The AES encryption data 65b is fed to a color data encryption unit 34b for encrypting data Cb/Cr denoting the color of each of these pixels.

The luminance data encryption unit 34a encrypts the AV data Y using the AES encryption data 65a and forwards the encrypted data to a superimposing unit 23. The color data encryption unit 34b encrypts the AV data Cb/Cr using the AES encryption data 65b and outputs the encrypted data. The luminance data encryption unit 34a and color data encryption unit 34b encrypt the AV data in frames using a frame reset 63E sent from a timing generator and a metadata generation unit 22.

The superimposing unit 23 superimposes metadata 64 coming from the metadata generation unit 22 onto the encrypted AV data Y supplied by the luminance data encryption unit 34a, and outputs the superimposed data.

As described, the encryption apparatus 11 encrypts the AV data formed by the AV data Y and AV data Cb/Cr through the use of the AES, which is one of common key encryption schemes. The encryption apparatus 11 proceeds to supply the decryption apparatus 12 with the encrypted AV data made up of the encrypted AV data Y and encrypted AV data Cb/Cr. The decryption apparatus 12 receives the encrypted AV data as its input.

A metadata extraction unit 41 extracts the metadata 64 and a timing signal from the encrypted AV data Y. The metadata extraction unit 41 proceeds to generate an LE key 61D and an AES input 62D out of the metadata 64 and a frame reset 63D out of the timing signal before feeding what is generated to a decryption unit 42.

The decryption unit 42 generates AES decryption data for decrypting the encrypted AV data, using the LE key 61D and AES input 62D coming from the metadata extraction unit 41. A P-P conversion unit 52 and stream conversion units 53a and 53b turn the AES decryption data 66 into two kinds of AES decryption data 66a and 66b. The AES decryption data 66a is supplied to a luminance data decryption unit 54a for decrypting the encrypted AV data Y. The AES decryption data 66b is fed to a color data decryption unit 54b for decrypting the encrypted AV data Cb/Cr.

The luminance data decryption unit 54a decrypts the encrypted AV data Y using the AES decryption data 66a and outputs the decrypted AV data Y. The color data decryption unit 54b decrypts the encrypted AV data Cb/Cr using the AES decryption data 66b and outputs the decrypted AV data Cb/Cr. Furthermore, the luminance data decryption unit 54a and color data decryption unit 54b decrypt the encrypted AV data in frames using the frame reset 63D coming from the metadata extraction unit 41.

In the ordinary encryption and decryption system 1, as described above, the encryption apparatus 11 encrypts AV data and supplies the encrypted AV data to the decryption apparatus 12. In turn, the decryption apparatus 12 decrypts the encrypted AV data coming from the encryption apparatus 11 and outputs the AV data.

When the encryption and decryption system 1 is utilized as an image repeater system that repeats AV data, a synchronizing signal defined by the HD-SDI standard is left unencrypted in the encrypted AV data sent from the encryption apparatus 11 at the transmission site to the decryption apparatus 12 at the reception site. The unencrypted synchronizing signal allows a monitoring unit located at a repeater site with no common key for decryption (called the repeater site monitor hereunder) to display images representative of the encrypted AV data on the screen. In this case, an image data part of the encrypted AV data is replaced by values with a high degree of pseudo-randomness. This results in a display of the so-called sandstorm noise all over the screen of the repeater site monitor. Although the obscured screen is inevitable because of encryption, monitoring personnel monitoring the repeater site are unable to identify images being displayed on the repeater site monitor.

This applicant proposed earlier an image half-disclosure technique in the form of an image encoding apparatus and an image decoding apparatus for partially encrypting data encoded according to the JPEG 2000 (Joint Photographic Experts Group 200) standard (e.g., see Japanese Patent Laid-open No. 2003-153228). The applicant also proposed a variable length data encoding method for encoding half-disclosed content signals representative of the contents to be encoded (e.g., see Japanese Patent Laid-open No. 2003-230096).

### SUMMARY OF THE INVENTION

One problem with the above-outlined ordinary apparatuses was that it was difficult to determine whether the image being displayed on the monitor screen at the repeater site with no common key for decryption was a noise or an encrypted image. More specifically, the encrypted AV data supplied by the encryption apparatus 11 in the ordinary encryption and decryption system 1 above could not be displayed as images recognizable by monitoring personnel viewing the monitor of the repeater site with no common key for decryption; the data could only be decrypted into recognizable images by the decryption apparatus 12 having the common key for decryption.

Another problem was that it was difficult to verify on the monitor screen erroneous distribution of data caused by inadvertent selection of a wrong repeater route.

The techniques proposed in the above-cited patent applications deal with compressed image data based on the MPEG (Moving Picture Experts Group) or JPEG standard and are difficult to be applied to baseband video signals. In some setups, part of the screen is obscured by pixelation for privacy protection. In such cases, the receiving side is difficult to decrypt the pixilated image portion back to the original form.

The present invention has been made in view of the above circumstances and provides an information processing apparatus, an information processing method, and a program for identifiably displaying part of an image corresponding to converted image data.

In carrying out the present invention and according to one embodiment thereof, an information processing apparatus for converting a first signal furnished as an input baseband video signal into a second signal to be output includes: a conversion unit configured to convert the first signal into the second signal of a predetermined system; a delay unit configured to delay the first signal to ensure synchronism with the second signal following the conversion; and a selection unit configured to select either the delayed first signal or the second signal in accordance with a third signal. The selection unit outputs either the delayed first signal or the second signal that has been selected.

Preferably, the conversion unit may encrypt the first signal for conversion into the second signal.

The conversion involving the encryption may preferably be based on the Advanced Encryption Standard known as the AES.

Preferably, the conversion unit may decrypt the first signal for conversion into the second signal.

The conversion involving the decryption may preferably be based on the AES as well.

Preferably, the first signal may be a video signal based on a standard known as HD-SDI which stands for the High Definition Serial Digital Interface.

Preferably, the third signal may be provided in such a manner that the first signal is selected for an area of each of frames constituting an image corresponding to the first signal and that the second signal is selected for another area of each of the frames making up the image.

According to another embodiment of the present invention, an information processing method is for use with an information processing apparatus for converting a first signal furnished as an input baseband video signal into a second signal to be output. The information processing method includes the steps of: converting the first signal into the second signal of a predetermined system; delaying the first signal to ensure synchronism with the second signal following the conversion; and selecting either the delayed first signal or the second signal in accordance with a third signal. The selecting step outputs either the delayed first signal or the second signal that has been selected.

According to a further embodiment of the present invention, a program is for use with a computer of an information processing apparatus for converting a first signal furnished as an input baseband video signal into a second signal to be output. The program causing the computer to execute a procedure includes the steps of: converting the first signal into the second signal of a predetermined system; delaying the first signal to ensure synchronism with the second signal following the conversion; and selecting either the delayed first signal or the second signal in accordance with a third signal. The selecting step outputs either the delayed first signal or the second signal that has been selected.

Where the information processing apparatus of the embodiment of the present invention is in use, the first signal is converted into the second signal, before being delayed to ensure synchronism with the second signal following the conversion. Either the delayed first signal or the converted second signal is selected in accordance with the third signal furnished for selection purposes. After the selection, the first or the second signal is output.

According to the embodiment of the present invention, as outlined above, part of the image corresponding to the converted image data may be displayed. In particular, equipment with no common key for decryption can still display part of the image on its screen thanks to the so-called image half-disclosure technique for leaving unencrypted part of the image during real-time encryption of HD-SDI baseband video signals.

### BRIEF DESCRIPTION OF THE DRAWINGS

FIG. 1 is a block diagram showing a typical structure of an ordinary encryption and decryption system;

FIG. 2 is a block diagram showing a typical structure of an encryption and decryption system according to the embodiment of the present invention;

FIG. 3 is a schematic view showing a screen of a repeater site monitor;

FIG. 4 is a schematic view showing another screen of the repeater site monitor;

FIG. 5 is a schematic view showing yet another screen of the repeater site monitor;

FIG. 6 is a block diagram showing a typical structure of the encryption and decryption system highlighting an encryption apparatus and a decryption apparatus according to the embodiment of the present invention;

FIG. 7 is a block diagram explanatory of a more detailed structure of the encryption and decryption system in FIG. 6;

FIG. 8 is a block diagram showing a detailed structure of a selection unit;

FIG. 9 is a schematic view explanatory of a key signal;

FIG. 10 is a tabular view detailing how switches operate in response to a control signal coming from a comparator;

FIG. 11 is a flowchart of steps constituting a partial encryption process of the encryption apparatus;

FIG. 12 is a flowchart of steps constituting a partial decryption process of the decryption apparatus; and

FIG. 13 is a block diagram showing a typical structure of a personal computer that executes programs according to the embodiment of the present invention.

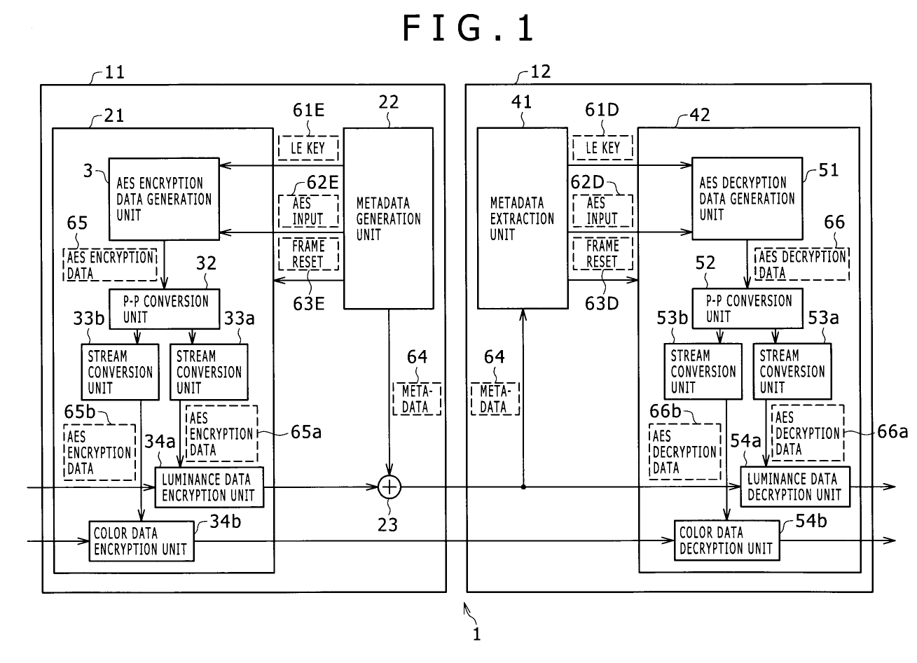

### DETAILED DESCRIPTION OF THE PREFERRED EMBODIMENTS

What is described below as the preferred embodiments of the present invention with reference to the accompanying drawings corresponds to the appended claims as follows: the description of the preferred embodiments basically provides specific examples supporting what is claimed. If any example of the invention described below as a preferred embodiment does not have an exactly corresponding claim, this does not means that the example in question has no relevance to the claims. Conversely, if any example of the invention described hereunder has a specifically corresponding claim, this does not mean that the example in question is limited to that claim or has no relevance to other claims.

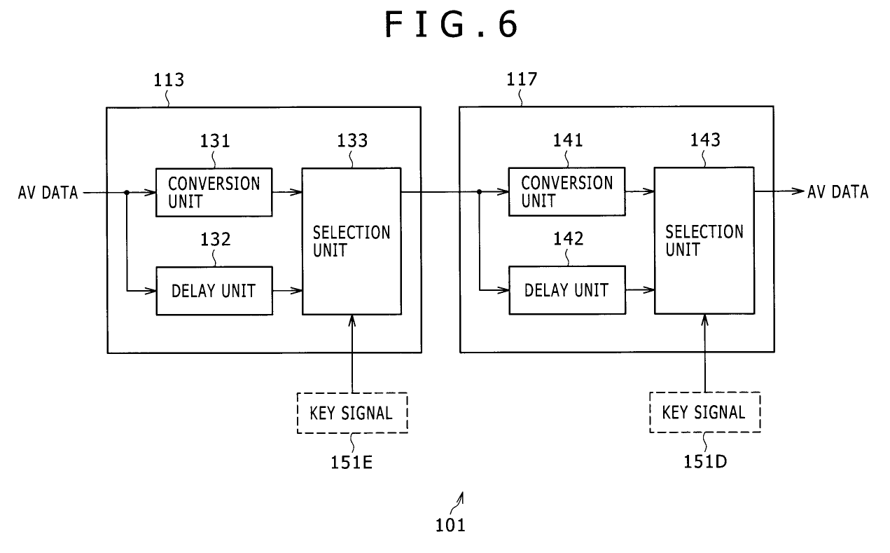

One preferred embodiment of the present invention is an information processing apparatus (e.g., encryption apparatus 113 in FIG. 6) for converting a first signal furnished as an input baseband video signal into a second signal to be output. The information processing apparatus includes: a conversion unit (e.g., conversion unit 131 in FIG. 6) configured to convert the first signal into the second signal of a predetermined system; a delay unit (e.g., delay unit 132 in FIG. 6) configured to delay the first signal to ensure synchronism with the second signal following the conversion; and a selection unit (e.g., selection unit 133 in FIG. 6) configured to select either the delayed first signal or the second signal in accordance with a third signal. The selection unit outputs either the delayed first signal or the second signal that has been selected.

Preferably, the conversion unit may encrypt the first signal for conversion into the second signal.

The conversion involving the encryption may preferably be based on the Advanced Encryption Standard known as the AES.

Preferably, the conversion unit may decrypt the first signal for conversion into the second signal.

The conversion involving the decryption may preferably be based on the AES as well.

Preferably, the first signal may be a video signal based on a standard known as HD-SDI which stands for the High Definition Serial Digital Interface.

Preferably, the third signal may be provided in such a manner that the first signal is selected for an area of each of frames constituting an image corresponding to the first signal and that the second signal is selected for another area of each of the frames making up the image.

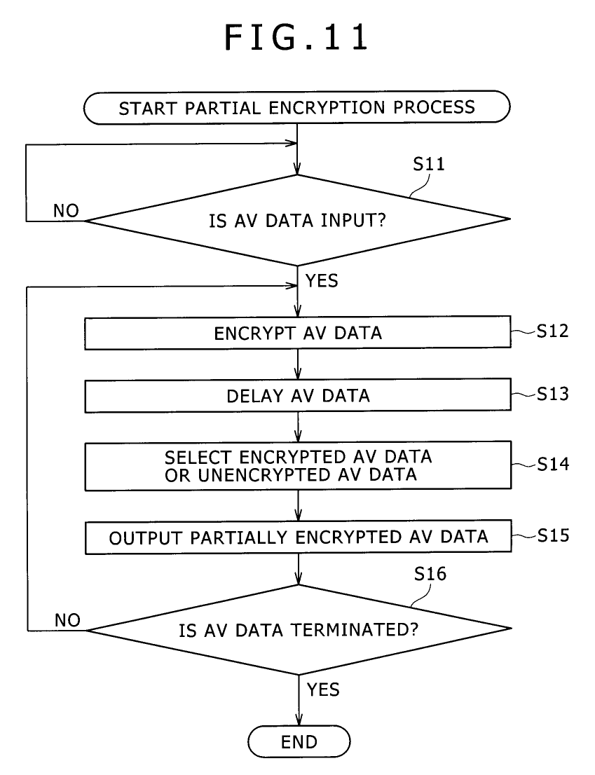

Another preferred embodiment of the present invention is an information processing method or a program for use respectively with an information processing apparatus or with a computer of the apparatus for converting a first signal furnished as an input baseband video signal into a second signal to be output. The method or the program causing the apparatus or the computer respectively to execute a process or a procedure includes the steps of: converting (e.g., in step S12 of FIG. 11) the first signal into the second signal of a predetermined system; delaying (e.g., in step S13 of FIG. 11) the first signal to ensure synchronism with the second signal following the conversion; and selecting (e.g., in step S14 of FIG. 11) either the delayed first signal or the second signal in accordance with a third signal. The selecting step outputs (e.g., in step S15 of FIG. 11) either the delayed first signal or the second signal that has been selected.

The preferred embodiments of the present invention will now be described in more detail with reference to the accompanying drawings.

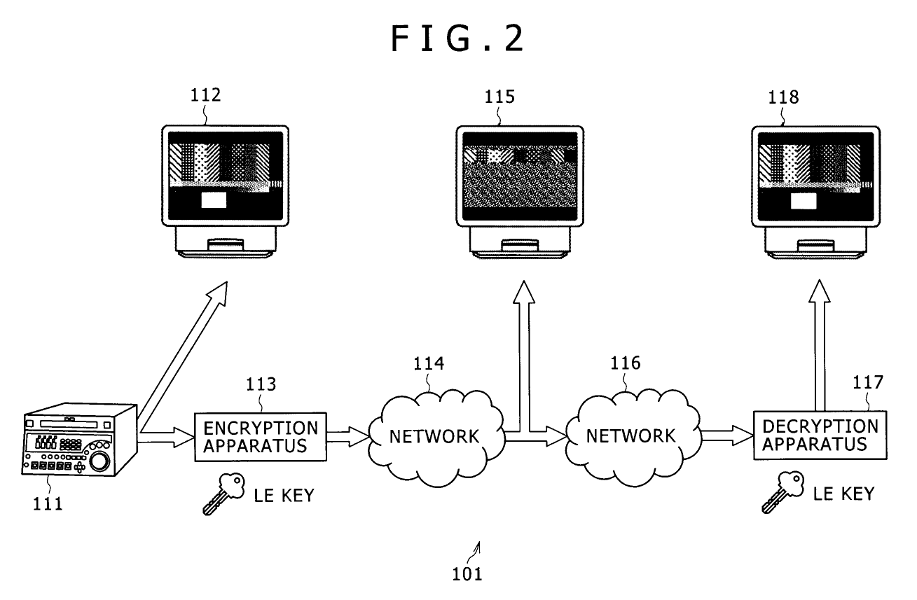

FIG. 2 is a block diagram showing a typical structure of an encryption and decryption system 101 according to the embodiment of the present invention.

The encryption and decryption system 101 is made up of an image output apparatus ill, a transmission site monitor 112, an encryption apparatus 113, a repeater site monitor 115, a decryption apparatus 117, and a reception site monitor 118. The encryption apparatus 113 and decryption apparatus 117 are connected with each other by way of networks 114 and 116. Also connected via the networks are the transmission site monitor 112 that monitors AV data representative of stream data constituting images in frames (e.g., contents such as movies) for input to the encryption apparatus 113, the repeater site monitor 115 that monitors AV data sent from the network 114 to the network 116, and the reception site monitor 118 that monitors AV data to be output by the decryption apparatus 117.

In other words, the encryption and decryption system 101 is an image repeating system that repeats AV data. The AV data may illustratively be HD-SDI data making up a baseband video signal constituted by data of at least one frame. It is assumed that each frame is formed by AV data Y representing the luminance of each of the pixels constituting the frame in question and by AV data Cb/Cr denoting the color of each of the pixels making up the frame. Although the ensuing description of this embodiment will present the HD-SDI baseband video signal as a representative signal, this is not limitative of the invention. Any other suitable baseband digital video signal may be adopted instead.

The image output apparatus 111 supplies image data such as AV data to the transmission site monitor 112 and encryption apparatus 113.

The transmission site monitor 112 displays on its screen an image corresponding to the AV data fed from the image output apparatus 111. This allows personnel monitoring the transmission site to verify, on the screen of the transmission site monitor 112, the image corresponding to the AV data yet to be encrypted by the encryption apparatus 113. The image displayed on the screen of the transmission site monitor 112 is obviously recognizable by monitoring personnel because the image has yet to be encrypted.

The encryption apparatus 113 encrypts part of the AV data supplied by the image output apparatus 11 illustratively through the use of a common key (called the LE key for this embodiment; it may otherwise be called the AES key) for AV data encryption based on the AES. The partially encrypted AV data is sent over the networks 114 and 116 to the decryption apparatus 117. As will be discussed later in more detail, the encryption apparatus 113 encrypts the AV data not totally but partially, illustratively encrypting only the areas other than a particular area of each of the frames constituting the image of the AV data in question.

The encryption apparatus 113 is connected to the network 114 and the decryption apparatus 117 to the network 116. The repeater site monitor 115 is connected interposingly between the networks 114 and 116. The networks 114 and 116 are constituted by interconnected networks or communication circuits such as the Internet, and they allow the encryption apparatus 113 and decryption apparatus 117 to communicate with each other in keeping with suitable protocols such as TCP/IP (Transmission Control Protocol/Internet Protocol).

The repeater site monitor 115 displays on its screen an image corresponding to AV data which is sent from the encryption apparatus 113 to the decryption apparatus 117 and which is passed from the network 114 on to the network 116. Personnel monitoring the repeater site can thus verify, on the screen of the repeater site monitor 115, the AV data partially encrypted by the encryption apparatus 113 and yet to be decrypted by the decryption apparatus 117. Usually, the image appearing on the screen of the repeater site monitor 115 is encrypted and therefore unrecognizable by monitoring personnel. By contrast, the AV data sent by the encryption apparatus 113 is partially encrypted and thus makes up a partially recognizable image for the monitoring personnel to verify.

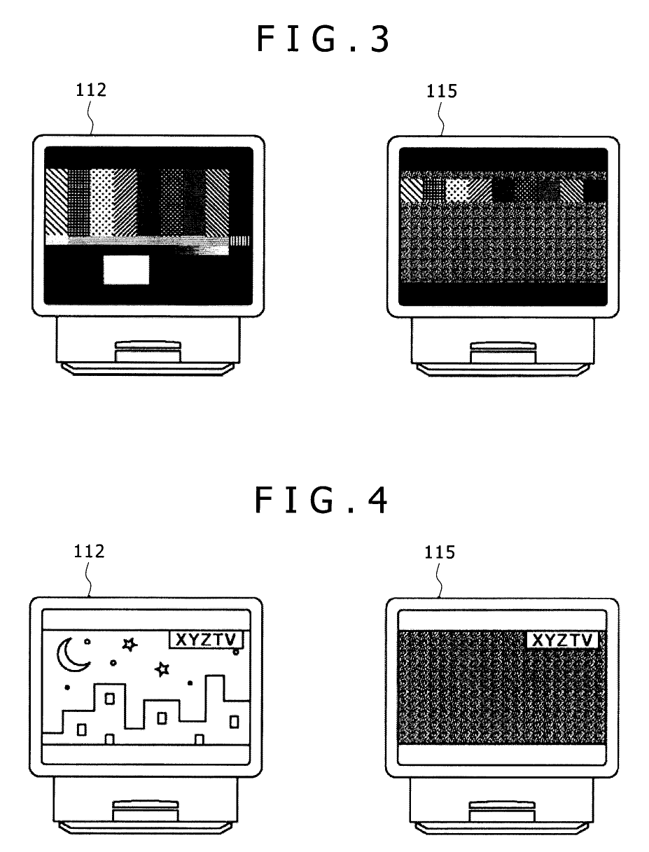

Images corresponding to the partially encrypted AV data are described below in more detail with reference to FIGS. 3 through 5. In each of FIGS. 3 through 5, the left-hand side picture represents an image appearing on the screen of the transmission site monitor 112, and the right-hand side picture denotes an image displayed on the screen of the repeater site monitor 115. In other words, the image being displayed on the screen of the transmission site monitor 112 represents the AV data yet to be encrypted by the encryption apparatus 113, and the image appearing on the screen of the repeater site monitor 115 denotes the AV data partially encrypted by the encryption apparatus 113.

In the example of FIG. 3, the transmission site monitor 112 on the left-hand side is seen displaying on its screen a color bar as a test pattern corresponding to the AV data. The color bar is displayed all over the screen of the transmission site monitor 112 because the AV data has yet to be encrypted. On the other hand, the repeater site monitor 115 to the right is seen displaying on its screen another color bar corresponding to the partially encrypted AV data coming from the encryption apparatus 113 over the network 114. On the screen of the repeater site monitor 115, the encrypted portion of the partially encrypted AV data is displayed as an unrecognizable image while the unencrypted portion of the data is displayed as the color bar.

The repeater site monitor 115, although not in possession of the common key (LE key), thus displays (i.e., discloses) that part of the color bar which is left unencrypted by the so-called image half-disclosure technique. In this manner, the repeater site monitor 115 permits monitoring of video characteristics using the monitor-destined image at a site for repeating AV data.

In the example of FIG. 4, the transmission site monitor 112 on the left-hand side is seen displaying on its screen an image (e.g., a night view in FIG. 4) corresponding to the AV data supplied by the image output apparatus 111. As in the example of FIG. 3, the transmission site monitor 112 displays a recognizable image all over its screen because the AV data at this point has yet to be encrypted. The repeater site monitor 115 shown to the right displays a partially unrecognizable image corresponding to the AV data partially encrypted and forwarded by the encryption apparatus 113 over the network 114, as in the case of FIG. 3. What is displayed on the repeater site monitor screen also includes unencrypted symbols (e.g., “XYZTV” in FIG. 4, a call sign of a broadcasting station).

Although not in possession of the common key (LE key), the repeater site monitor 115 can thus allow monitoring personnel to recognize video attributes of the repeated image meaningfully representing, say, an unencrypted broadcasting station call sign (“XYZTV”) at an AV data repeater site. The partially disclosed symbol portion is not limited to still images; it may be a moving picture, a bar code, or other diverse data that may be displayed as a recognizable image.

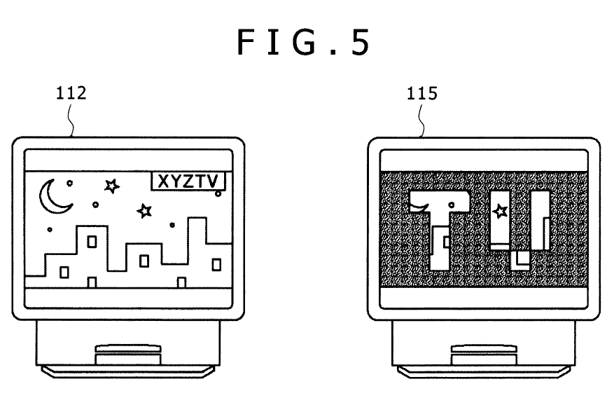

In the example of FIG. 5, the transmission site monitor 112 on the left-hand side displays on its screen an image (e.g., a night view in FIG. 4) corresponding to the AV data supplied by the image output apparatus 111. As in the example of FIG. 3, the transmission site monitor 112 displays a recognizable image all over its screen because the AV data at this point has yet to be encrypted. The repeater site monitor 115 shown to the right displays a partially unrecognizable image corresponding to the AV data partially encrypted and forwarded by the encryption apparatus 113 over the network 114, as in the case of FIG. 3. What is displayed on the repeater site monitor screen also includes unencrypted character shapes (e.g., characters “TV” in FIG. 5).

Without the common key (LE key), the repeater site monitor 115 can thus enable monitoring personnel to recognize video attributes of the repeated image meaningfully representing, say, unencrypted character shapes (“TV”) at an AV data repeater site. The partially disclosed character shapes are not limited to alphabetic characters shown in FIG. 5; they may be other diverse characters or patterns that may be displayed as recognizable shapes in pixels.

In FIGS. 3 through 5, the left-hand side pictures were shown representing the images appearing on the screen of the transmission site monitor 112. The reception site monitor 118, to be discussed later, will display similar images representative of the decrypted AV data.

Returning to FIG. 2, the decryption apparatus 117 receives the AV data partially encrypted and forwarded by the encryption apparatus 113 over the networks 114 and 116. The decryption apparatus 117 decrypts the partially encrypted AV data using the same LE key that was used by the encryption apparatus 113 for encryption. The decrypted AV data is supplied to the reception site monitor 118.

The reception site monitor 118 displays on its screen the AV data fed from the decryption apparatus 117. This allows personnel monitoring the reception site to verify, on then screen of the reception site monitor 118, the AV data partially encrypted by the encryption apparatus 113 and decrypted by the decryption apparatus 117. Having undergone decryption, the image on the screen of the reception site monitor 118 at this point is recognizable by monitoring personnel.

More specifically, with the AV data decrypted back to the original form, the reception site monitor 118 displays the color bar all over its screen as in the case of the transmission site monitor 112 described above.

FIG. 6 is a block diagram showing a typical structure of the encryption and decryption system 101 highlighting the encryption apparatus 113 and decryption apparatus 117 according to the embodiment of the present invention. That is, the setup of FIG. 6 indicates the encryption apparatus 113 and decryption apparatus 117 selected from the components making up the encryption and decryption system 101 of FIG. 2. The two apparatuses will be discussed below in more detail.

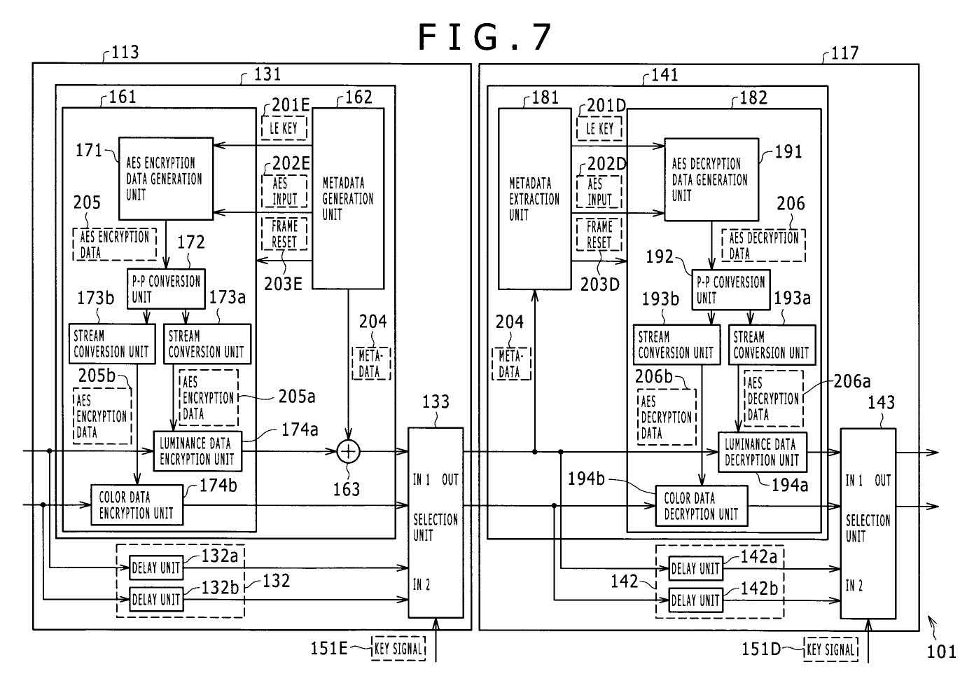

In reference to FIG. 2, the encryption apparatus 117 was described above as partially encrypting AV data and the decryption apparatus 117 as decrypting the partially encrypted AV data. However, this is not limitative of the invention; the conversion of AV data is not limited to decryption and decryption. Diverse variations of data conversion may be adopted. Data conversion that covers methods other than encryption and decryption will be discussed below with reference to FIG. 6. Specific examples of the conversion centering on encryption and decryption will be described later by referring to FIGS. 7 through 12 as well as to FIG. 6.

The setup of FIG. 6 is made up of the encryption apparatus 113 and decryption apparatus 117. The encryption apparatus 113 illustratively converts AV data using a particular method such as encryption. The decryption apparatus 117 decrypts the AV data encrypted by the encryption apparatus 113 through the use of a decryption method paired with the encryption scheme of the upstream apparatus.

Illustratively, the encryption apparatus 113 converts the AV data input from the image output apparatus 111 in accordance with a suitable encryption method and forwards the encrypted AV data to the decryption apparatus 117 by way of the networks 114 and 116. The encryption apparatus 113 is structured to include a conversion unit 131, a delay unit 132, and a selection unit 133.

The conversion unit 131 converts the AV data coming from the image output apparatus 111 in accordance with the predetermined method and sends the converted AV data to the selection unit 133. More specifically, the conversion unit 131 may encrypt the AV data and supply the encrypted AV data to the selection unit 133. Instead of resorting to encryption, the conversion unit 131 may alternatively convert the AV data through a scrambling process.

The delay unit 132 delays by a suitable time period the AV data coming from the image output apparatus 111 and sends the delayed AV data to the selection unit 133. It takes some time for the conversion unit 131 to convert the input AV data. In view of that converting time, the delay unit 132 delays its own input AV data in such a manner that the AV data output by the conversion unit 131 and the AV data output by this delay unit 132 will enter the selection unit 133 synchronously.

The selection unit 133 admits a key signal 151E in addition to the converted AV data coming from the conversion unit 131 as well as the delayed AV data from the delay unit 132. As will be discussed later in more detail, the key signal 151E is a signal that causes the selection unit 133 to select either of the synchronously input AV data items from the conversion unit 131 and delay unit 132.

The selection unit 133 thus selects either the converted AV data or the unconverted AV data which have been input synchronously, on the basis of the input key signal 151E. The selected AV data is supplied to the decryption apparatus 117. Consequently, the AV data fed to the decryption unit 117 is turned into partially converted data illustratively representing an image in frames, part of each of the frames being left unconverted.

The decryption apparatus 117 converts the partially converted AV data coming from the encryption apparatus 113 over the networks 114 and 116, through the use of a predetermined method paired with the conversion method adopted by the encryption apparatus 113. The AV data thus decrypted is output illustratively to the reception site monitor 118. The decryption apparatus 117 is structured to include a conversion unit 141, a delay unit 142, and a selection unit 143.

The conversion unit 141 converts the partially converted AV data coming from the encryption apparatus 113 back to the original form by use of the predetermined method. The reconstructed AV data following the conversion is supplied to the selection unit 143. More specifically, the conversion unit 141 may decrypt the partially encrypted AV data and send the decrypted AV data to the selection unit 143. Instead of resorting to decryption, the conversion unit 141 may alternatively convert the AV data through a descrambling process.

The delay unit 142 delays by a suitable time period the AV data coming from the encryption apparatus 113 and sends the delayed AV data to the selection unit 143. As in the case of the encryption apparatus 113, the decryption apparatus 141 thus allows the AV data coming from the conversion unit 141 and the AV data from the delay unit 142 to enter the selection unit 143 synchronously.

The selection unit 143 admits a key signal 151D in addition to the converted AV data coming from the conversion unit 141 as well as the delayed AV data from the delay unit 142. As will be discussed later in more detail, the key signal 151D is a signal which corresponds to the key signal 151E and which causes the selection unit 143 to select either of the synchronously input AV data items from the conversion unit 141 and delay unit 142.

The selection unit 143 thus selects either the synchronously input AV data converted back to the original form or the unconverted AV data (i.e., partially converted AV data) also input synchronously, on the basis of the input key signal 151D. The selected AV data is supplied illustratively to the reception site monitor 118.

By treating the key signal 151D on the same level as the key signal 151E, the selection unit 143 selects the supplied AV data at the same time as the selection unit 133 selects its own supplied AV data. Following the process, the AV data output by the decryption apparatus 117 comes out in two forms: the reconstructed AV data having undergone conversion by the encryption apparatus 113, and the unconverted AV data not undergoing conversion by the encryption apparatus 113.

The key signals 151E and 151D may be placed beforehand in the encryption apparatus 113 and decryption apparatus 117, respectively. Alternatively, an external device may supply the encryption apparatus 113 and decryption apparatus 117 with the key signals 151E and 151D, respectively, issued on the same level.

In the setup of FIG. 6, the repeater site monitor 115 located as shown in FIG. 2 would be positioned where it could intercept the AV data coming out of the encryption apparatus 113 and yet to reach the decryption apparatus 117. Thus located, the repeater site monitor 115 would display on its screen images such as those shown on the right-hand side of each of FIGS. 3 through 5.

A more specific case of conversion involving the encryption apparatus 113 and decryption apparatus 117 will now be described. This will be an example in which the encryption and decryption system 101 is explained in more detail, formed by the encryption apparatus 113 that encrypts AV data and by the decryption apparatus 117 that decrypts the encrypted AV data.

FIG. 7 is a block diagram explanatory of a more detailed structure of the encryption and decryption system 101 shown in FIG. 6.

In the example of FIG. 7, the encryption apparatus 113 encrypts AV data using the AES, which is one of common key encryption schemes. The conversion unit 131 of the encryption apparatus 113 is thus constituted by an encryption unit 161, a metadata generation unit 162, and a superimposing unit 163. The encryption unit 161 is made up of an AES encryption data generation unit 171, a P-P conversion unit 172, stream conversion units 173a and 173b, a luminance data encryption unit 174a, and a color data encryption unit 174b. Of the components involved, those similar or corresponding to the units shown in FIG. 6 will be given the same reference numerals and their explanations will be omitted where redundant in the ensuing description.

The AES encryption data generation unit 171 generates data for direct AV data encryption (the generated data will be called the AES encryption data 205 hereunder) using an AES input 202E and a common key 201E for encrypting AV data in accordance with the AES. The AES encryption data 205 thus generated is sent to the P-P conversion unit 172.

The P-P conversion unit 172 is supplied with the AES encryption data 205 from the AES encryption data generation unit 171. From the AES encryption data 205, the P-P conversion unit 172 extracts two forms of data: data for encrypting AV data Y representative of the luminance of each of the pixels constituting each of the frames making up the AV data, and data for encrypting AV data Cb/Cr indicative of the color of each of the pixels involved. The two extracted data streams are fed to the stream conversion units 173a and 173b respectively.

The stream conversion unit 173a converts the AV data Y supplied by the P-P conversion unit 172 by use of the predetermined method and feeds the converted data (called the AES encryption data 205a hereunder) to the luminance data encryption unit 174a. Likewise, the stream conversion unit 173b converts the AV data Cb/Cr using the predetermined method and supplies the converted data (called the AES encryption data 205b) to the color data encryption unit 174b.

In the above setup, the AES encryption data generation unit 171 generates the AES encryption data 205 of 128 bits from 256-bit input data formed by the LE key 201E of 128 bits and by the AES input 202E of 128 bits. The AES encryption data 205 thus generated is supplied to the P-P conversion unit 172. From the 128-bit AES encryption data 205, the P-P conversion unit 172 extracts low-order 120 bits in increments of 10 bits as the data used actually to encrypt AV data. Following the extraction, the P-P conversion unit 172 sends the AES encryption data 205a and 205b to the luminance data encryption unit 174a and color data encryption unit 174b via the stream conversion units 173a and 173b, respectively.

The luminance data encryption unit 174a is given a choice between the AV data Y representing the luminance of each of the pixels constituting each of the frames of AV data and the AV data Cb/Cr denoting the color of each of the pixels making up each of the frames. Using the AES encryption data 205a coming from the stream conversion unit 173a in increments of 10 bits, the luminance data encryption unit 174a encrypts the AV data Y and feeds the encrypted AV data Y to the superimposing unit 163. In this case, the luminance data encryption unit 174a encrypts the AV data in increments of frames using a frame reset 203E supplied by the metadata generation unit 162.

The color data encryption unit 174b is also given a choice between the AV data Y and the AV data Cb/Cr making up the AV data. Using the AES encryption data 205b coming from the stream conversion unit 173b in increments of 10 bits, the color data encryption unit 174b encrypts the AV data Cb/Cr denoting the color of each of the pixels, and feeds the encrypted AV data Cb/Cr to the selection unit 133. In this case, as with the luminance data encryption unit 174a, the color data encryption unit 174b encrypts the AV data in increments of frames using the frame reset 203E.

The metadata generation unit 162 and timing generator generate various items of information necessary for encryption by the encryption unit 161 (i.e., information to be eventually necessary by the decryption apparatus 117 for decryption). The generated items of information illustratively include the LE key 201E, AES input 202E, and frame reset 203E among others, as mentioned above. The metadata generation unit 162 adds some of these items of information as supplementary information to the LE key 201E to create data called LEKP (Link Encryption Key Payload). The metadata generation unit 162 proceeds to encrypt the LEKP illustratively in accordance with the RSA (R. Rivest, A. Shamir, L. Adleman) Cryptosystem (trademark; a 2048-bit encryption system) using a public key available on the side of the decryption apparatus 117. The LEKP encrypted by the RSA Cryptosystem is called ELEKP. This is how the metadata generation unit 162 generates ELEKP. In addition to ELEKP, the metadata generation unit 162 generates metadata 204 made up of a component of the AES input 202E and other data, and sends the generated metadata 204 to the superimposing unit 163.

The superimposing unit 163 superimposes the metadata 204 generated by the metadata generation unit 162 onto the encrypted AV data Y from the luminance data encryption unit 174a illustratively in the V blanking period. The resulting data (called the metadata-superimposed encrypted AV data Y) is sent from the superimposing unit 163 to the selection unit 133. At this point, the metadata 204 is superimposed in increments of frames. As mentioned above, the encrypted AV data is composed of the encrypted AV data Y (i.e., metadata-superimposed encrypted AV data Y) and the encrypted AV data Cb/Cr.

Out of the AV data Y and AV data Cb/Cr constituting the input AV data, the delay unit 132a delays by a suitable time period the AV data Y denoting the luminance of each of the pixels involved. The delayed AV data (called the unencrypted AV data Y hereunder) is fed to the selection unit 133. Likewise, the delay unit 132a delays by a suitable time period the AV data Cb/Cr representing the color of each of the pixels (called the unencrypted AV data Cb/Cr hereunder) and supplies the delayed data to the selection unit 133. In the ensuing decryption, the unencrypted AV data Y and the unencrypted AV data Cb/Cr will be referred to generically as the unencrypted AV data.

It takes some time for the conversion unit 131 to convert the input AV data. In view of that converting time, the delay units 132a and 132b delay respectively the AV data Y and the AV data Cb/Cr constituting the input AV data in such a manner that the encrypted AV data Y and AV data Cb/Cr output by the conversion unit 131 and the unencrypted AV data Y and AV data Cb/Cr output by these delay units 132a and 132b will enter the selection unit 133 synchronously. In other words, the encrypted AV data and the unencrypted AV data are input synchronously to the selection unit 133.

The selection unit 133 is given the following input: the metadata-superimposed encrypted AV data Y coming from the superimposing unit 163 as an input signal IN1, the encrypted AV data Cb/Cr also sent as the input signal IN1 from the color data encryption unit 174b, the unencrypted AV data Y sent as an input signal IN2 from the delay unit 132a, the unencrypted AV data Cb/Cr also sent as the input signal IN2 from the delay unit 132b, and the key signal 151E.

On the basis of the key signal 151E, the selection unit 133 selects either the metadata-superimposed encrypted AV data Y (input signal IN1) or the unencrypted AV data Y (input signal IN2) as the AV data Y representing the luminance of each of the pixels, and selects either the encrypted AV data Cb/Cr (input signal IN1) or the unencrypted AV data Cb/Cr (input signal IN2) as the AV data Cb/Cr indicating the color of each of the pixels. The selection unit 133 proceeds to supply the selected AV data Y (called the partially encrypted AV data Y hereunder) and AV data Cb/Cr (called the partially encrypted AV data Cb/Cr hereunder) to the decryption apparatus 117. In the ensuing description, the partially encrypted AV data Y and the partially encrypted AV data Cb/Cr will be referred to generically as the partially encrypted AV data (output signal OUT).

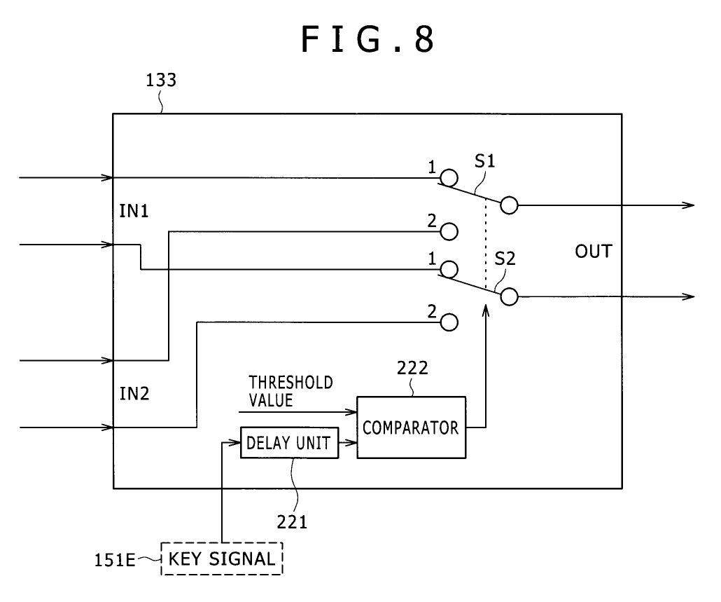

The selection unit 133 will now be described in more detail with reference to FIGS. 8 through 10. FIG. 8 is a block diagram showing a detailed structure of the selection unit 133.

As described above, the selection unit 133 selects either the input signal IN1 or the input signal IN2 based on the key signal 151E and forwards the selected input signal to the decryption apparatus 117 as the output signal OUT. The selection unit 133 is structured to include a delay unit 221, a comparator 222, and switches S1 and S2.

The key signal 151E is input to the delay unit 221. Illustratively, the delay unit 221 delays a Y signal constituting a luminance component of the key signal 151E in such a manner that the delayed signal component will enter the comparator 222 in synchronism with the input signals IN1 and IN2.

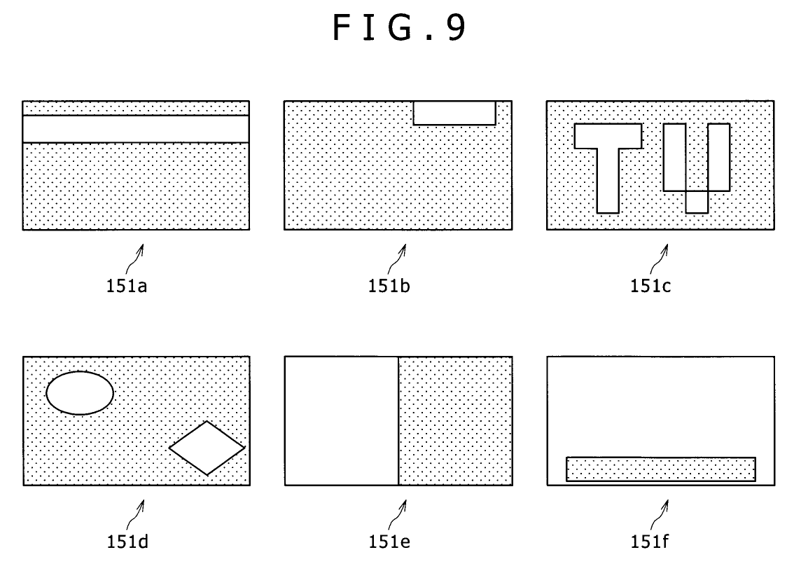

As shown in FIG. 9, the key signal 151E is illustratively representative of a black-and-white binary level screen. More specifically, six screens indicated in FIG. 9 are constituted respectively by keys signals 151a through 151f each being a variation of the key signal 151E.

The key signals 151a through 151f each make up white (shown blank) and black (shown shaded) areas. The white areas represent areas that are left unencrypted, and the blank areas denote areas that are encrypted.

Individually, the key signal 151a is furnished as a signal that leaves a band-shaped blank strip unencrypted while encrypting the remaining shaded areas as illustrated. When the AV data is encrypted by the encryption apparatus 113 based on the key signal 151a, the repeater site monitor 115 displays on its screen an image such as the one shown on the right-hand side of FIG. 3 in which part of the color bar is displayed as a band-shaped strip.

Likewise, the key signal 151b is furnished as a signal that leaves a rectangular area in the top right corner unencrypted while encrypting the remaining areas as illustrated. When the key signal 151b is utilized, the repeater site monitor 115 displays on its screen an image such as the one shown on the right-hand side of FIG. 4 in which only the rectangular area in the top right corner appears in recognizable fashion. Similarly, the key signal 151c is furnished as a signal that leaves character-shaped areas (“TV”) of the screen unencrypted while encrypting the remaining areas. When the key signal 115c is employed, the repeater site monitor 115 displays on its screen an image such as the one shown on the right-hand side of FIG. 5 in which only the character-shaped areas (“TV”) are indicated recognizably.

The unencrypted white areas can take divers shapes including the above-described band-shaped strip, rectangular shape in the top right corner, and character-shaped areas (“TV”). The unencrypted white areas can also be an ellipse and a lozenge designated by the key signal 151d, a left-hand half screen area designated by the key signal 151e, or an entire display screen except for a rectangle at the screen bottom as designated by the key signal 151f as illustrated, or other suitable shapes.

The display areas to be encrypted can be varied as desired by suitably modifying the key signal 151E. This makes it possible to keep in balance the confidentiality of a given image and the tolerable degree of its disclosure on the screen of the repeater site monitor 115.

The comparator 222 receives a predetermined threshold value in addition to the key signal 151E coming from the delay unit 221. The comparator 222 compares the key signal 151E with the threshold value, and supplies the switches S1 and S2 with a control signal reflecting the result of the comparison. The switches S1 and S2 perform their switching actions in accordance with the control signal supplied by the comparator 222.

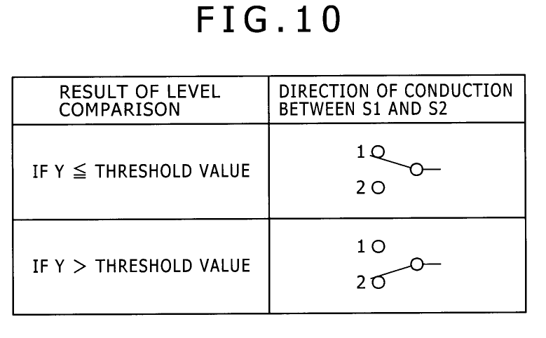

FIG. 10 is a tabular view detailing how the switches S1 and S2 operate in response to the control signal coming from the comparator 222. In the table of FIG. 10, the left-hand side column indicates the results of comparisons between the level of the key signal 151E and the threshold value, and the right-hand side column shows the directions of conduction on the switches S1 and S2 relative to the results of the comparisons in the left-hand side column.

If the Y signal as the luminance component of the key signal 151E is equal to or lower than the threshold value, as shown in the second row of the table in FIG. 10, then the switch S1 has its input switched to a line 1 receiving the encrypted AV data (i.e., metadata-superimposed encrypted AV data Y (input signal IN1)) in accordance with the control signal from the comparator 222. Likewise the switch S2 has its input switched to the line 1 admitting the encrypted AV data (i.e., encrypted AV data Cb/Cr (input signal IN1)) on the basis of the control signal from the comparator 222. The switch settings that cause the selection unit 133 to output the encrypted AV data when the Y signal as the luminance component of the key signal 151E is equal to or lower than the threshold value.

If the Y signal as the luminance component of the key signal 151E is higher than the threshold value, as shown in the third row of the table in FIG. 10, then the switch S1 has its input switched to a line 2 receiving the unencrypted AV data (i.e., unencrypted AV data Y (input signal IN2)) in accordance with the control signal from the comparator 222. Likewise the switch S2 has its input switched to the line 2 admitting the unencrypted AV data (i.e., unencrypted AV data Cb/Cr (input signal IN2)) on the basis of the control signal from the comparator 222. The switch settings thus cause the selection unit 133 to output the unencrypted AV data when the Y signal as the luminance component of the key signal 151E is higher than the threshold value.

In the foregoing description, the delay unit 221 was shown to let the Y signal constituting the luminance component of the key signal 151E enter the comparator 222. Alternatively, the delay unit 221 may allow a chroma signal (Cb/Cr signal) representing a color difference component of the key signal 115E to be input. In this case, the comparator 222 compares the predetermined threshold value with the Cb/Cr signal and supplies the switches S1 and S2 with a control signal reflecting the result of the comparison. As another alternative, the threshold value entering the comparator 222 may have its level not fixed but changed dynamically.

Returning to FIG. 7, the embodiment of the invention has the partially encrypted AV data (output signal OUT) generated by the encryption apparatus 113 and forwarded (i.e., offered) to the decryption apparatus 117 by way of the networks 114 and 116 as discussed above.

In the example of FIG. 7, the decryption apparatus 117 is structured to include the conversion unit 141, delay unit 142 (composed of the delay units 142a and 142b), and selection unit 143 as described above. The conversion unit 141 is structured to include a metadata extraction unit 181 and a decryption unit 182.

The metadata extraction unit 181 extracts the metadata 204 and other information from the metadata-superimposed encrypted AV data Y in the partially encrypted AV data offered by the encryption apparatus 113. Given the extracted information, the metadata extraction unit 181 generates an LE key 201D and an AES input 202D from the metadata 204, and a frame reset 203D from the timing signal. These generated items of information are supplied to the decryption unit 182. It should be noted that the LE KEY 201D, AES input 202D, and frame reset 203D are reconstructed respectively from the LE key 201E, AES input 202E, and frame reset 203E used by the encryption apparatus 113 for generating the encrypted AV data. For this reason, it may also be said that the metadata extraction unit 181 and the timing generator work to restore the LE key 201E, AES input 202E, and frame reset 203E before feeding them to the decryption unit 182.

In the example of FIG. 7, the decryption unit 182 is structured to include an AES decryption data generation unit 191, a P-P conversion unit 192, stream conversion units 193a and 193b, a luminance data decryption unit 194a, and a color data decryption unit 194b.

The AES decryption data generation unit 191 generates data (called the AES decryption data 206 hereunder) for directly decrypting the partially encrypted AV data (encrypted according to the AES) through the use of the LE key 201D and AES input 202D coming from the metadata extraction unit 181. The AES decryption data 206 thus generated is sent to the P-P conversion unit 192. That is, the AES decryption data 206 is data that is used to decrypt the ASE encryption data 205.

The P-P conversion unit 192 is supplied with the AES decryption data 206 from the AES decryption data generation unit 191. From the AES decryption data generation unit 191, the P-P conversion unit 192 acquires two kinds of data: data for decrypting the partially encrypted AV data Y representing the luminance of each of the pixels constituting each of the frames of AV data, and data for decrypting the partially encrypted AV data Cb/Cr denoting the color of each of the pixels involved. The P-P conversion unit 192 forwards the two kinds of data thus acquired to the stream conversion units 193a and 193b respectively.

The stream conversion unit 193a converts by a predetermined method the data for decrypting the partially encrypted AV data Y coming from the P-P conversion unit 192, and supplies the converted data (called the AES decryption data 206a hereunder) to the luminance data decryption unit 194a. Likewise, the stream conversion unit 193b converts by the predetermined method the data for decrypting the partially encrypted AV data Cb/Cr, and supplies the converted data (called the AES decryption data 206b hereunder) to the color data decryption unit 194b.

Using the AES decryption data 206a fed by the stream conversion unit 193a, the luminance data decryption unit 194a decrypts the metadata-superimposed encrypted AV data Y out of the partially encrypted AV data Y, and supplies the resulting AV data Y (called the decrypted AV data Y hereunder) to the selection unit 143. At this point, the luminance data decryption unit 194a decrypts the partially encrypted AV data Y in increments of frames using the frame reset 203D provided by the metadata extraction unit 181.

Using the AES decryption data 206b fed by the stream conversion unit 193b, the color data decryption unit 194b decrypts the encrypted AV data Cb/Cr out of the partially encrypted AV data Cb/Cr, and supplies the resulting AV data Cb/Cr (called the decrypted AV data Cb/Cr hereunder) to the selection unit 143. At this point, like the luminance data decryption unit 194a, the color data decryption unit 194b decrypts the encrypted AV data Cb/Cr in increments of frames using the frame reset 203D. In the ensuing decryption, the decrypted AV data Y and the decrypted AV data Cb/Cr will be referred to generically as the decrypted AV data.

The delay unit 142a delays by a suitable time period the partially encrypted AV data Y representing the luminance of each of the pixels involved out of the partially encrypted AV data supplied by the encryption apparatus 113, and forwards the delayed partially encrypted AV data Y (called the undecrypted AV data Y hereunder) to the selection unit 143. Likewise, the delay unit 142b delays by a suitable time period the partially encrypted AV data Cb/Cr denoting the color of each of the pixels involved out of the partially encrypted AV, and forwards the delayed partially encrypted AV data Cb/Cr (called the undecrypted AV data Cb/Cr hereunder) to the selection unit 143. In the ensuing description, the undecrypted AV data Y and the undecrypted AV data Cb/Cr will be referred to generically as the undecrypted AV data.

In the setup described above, the selection unit 143 admits four kinds of data synchronously: the decrypted AV data Y and the decrypted AV data Cb/Cr coming from the conversion unit 141, and the undecrypted AV data Y and the undecrypted AV data Cb/Cr output by the delay units 142a and 142b respectively. In other words, the decrypted AV data and the undecrypted AV data are input synchronously to the selection unit 143.

The selection unit 143 is given the key signal 151D in addition to the input signal IN1 constituted by the decrypted AV data Y coming from the luminance data decryption unit 194a and by the decrypted AV data Cb/Cr from the color data decryption unit 194b, and the input signal IN2 formed by the undecrypted AV data Y from the delay unit 142a and by the undecrypted AV data Cb/Cr from the delay unit 142b.

On the basis of the key signal 151D, the selection unit 143 selects either the decrypted data Y (input signal IN1) or the undecrypted AV data Y (input signal IN2) as the AV data Y representing the luminance of each of the pixels involved, and chooses either the decrypted data Cb/Cr (input signal IN1) or the undecrypted AV data Cb/Cr (input signal IN2) as the AV data Cb/Cr denoting the color of each of the pixels. The selection unit 143 then sends illustratively to the reception site monitor 118 an output signal OUT constituted by the selected AV data Y (called the partially decrypted AV data Y hereunder) and by the selected AV data Cb/Cr (called the partially decrypted AV data Cb/Cr hereunder). In the ensuing description, the partially decrypted AV data Y and the partially decrypted AV data Cb/Cr will be referred to generically as the partially decrypted AV data (output signal OUT).

The selecting operations of the selection unit 143 are the same as those of the above-described conversion unit 133 and thus will not be discussed further in detail. It should be noted, however, that the key signal 151D input to the selection unit 143 corresponds to the key signal 151E, e.g., one of the key signals 151a through 151f shown in FIG. 9. That is, if the selection unit 133 selects the input signal IN1 or IN2 using the key signal 151a, then the selection unit 143 selects the input signal IN1 or IN2 using the key signal 151a as well. In this manner, when the selection unit 133 selects the input signal IN1, the selection unit 143 also selects the input signal IN1; when the selection unit 133 selects the input signal IN2, the selection unit 143 selects the input signal IN2 likewise. In other words, the decryption apparatus 117 may be said to decrypt the AV data encrypted by the encryption apparatus 113 and to let the AV data not encrypted by the encryption apparatus 113 be output undecrypted (because there is no need for decryption).

The operations of the encryption apparatus 113 and decryption apparatus 117 in the encryption and decryption system 101 will now be explained.

The first to be described in reference to the flowchart of FIG. 11 is how the encryption apparatus 113 carries out partial encryption.

In step S11, the conversion unit 131 checks to determine whether AV data is input from the image output apparatus 111.

If no AV data is found input from the image output apparatus 111 in step S11, then step S11 is repeated. For example, step S11 is repeated until the image output apparatus 11 outputs AV data which is then found to be input to the encryption apparatus 113.

If in step S11 AV data is found input from the image output apparatus 111, step S12 is reached. In step S12, the conversion unit 131 encrypts the input AV data by use of the AES and sends the encrypted AV data to the selection unit 133.

In step S13, the delay unit 132 delays the AV data coming from the image output apparatus 111 in such a manner as to ensure synchronism with the encrypted AV data being output by the conversion unit 131, and feeds the delayed unencrypted AV data to the selection unit 133.

In step S14, the selection unit 133 selects either the encrypted AV data coming from the conversion unit 131 or the unencrypted AV data from the delay unit 132 on the basis of the key signal 151E that has been input, the encrypted and the unencrypted AV data being admitted synchronously. More specifically, if the key signal 151a (in FIG. 9) is input, the selection unit 133 selects the encrypted AV data for the display regions designated by the black area of the key signal 151a while choosing the unencrypted AV data for the display regions specified by the white area of the same signal.

In step S15, the selection unit 133 sends the partially encrypted AV data formed by the encrypted and the unencrypted AV data following the selection to the decryption apparatus 117 over the networks 114 and 116.

In step S16, the conversion unit 131 checks to determine whether the AV data input from the image output apparatus 111 is terminated.

If in step S16 the input AV data is not found to be terminated, then step S12 is reached again and steps S12 through S16 are repeated. That is, steps S12 through S16 are repeated until the AV data input from the image output apparatus 111 is found terminated in step S16.

If in step S16 the AV data coming from the image output apparatus 111 is found to have ended, then the encryption apparatus 113 terminates its partial encryption process; there is no more AV data out of the image output apparatus 111 that needs to be partially encrypted.

As described, the encryption apparatus 113 partially encrypts the AV data coming from the image output apparatus 111 and outputs the partially encrypted AV data.

When the AV data from the image output apparatus 111 is encrypted using the key signal 151a as in the above example, the repeater site monitor 115 illustratively displays on its screen a band-like color bar such as one shown in the right-hand side picture of FIG. 3.

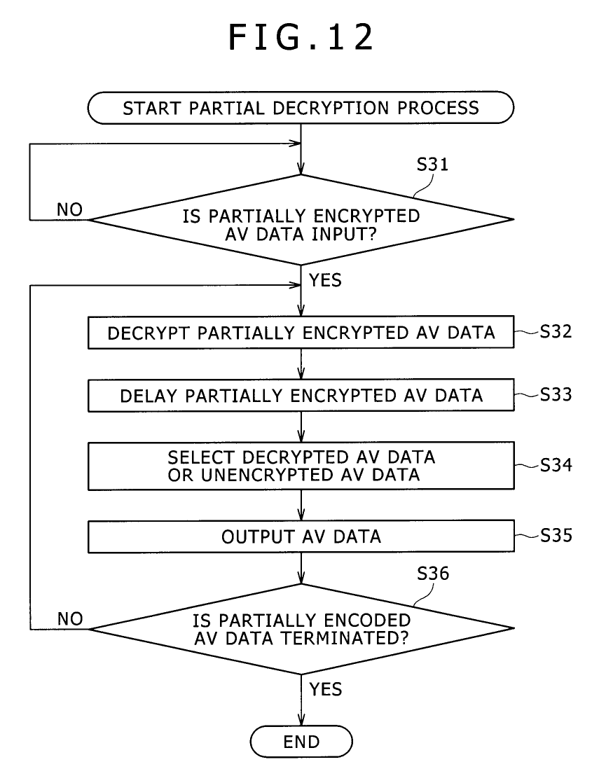

Described next in reference to the flowchart of FIG. 12 is the partial decryption process performed by the decryption apparatus 117.

In step S31, the conversion unit 141 checks to determine whether partially encrypted AV data is input from the encryption unit 113 by way of the networks 114 and 116.

If in step S31 no partially encrypted AV data is found input from the encryption unit 113, then step S31 is reached again and the check is repeated. Illustratively, step S31 is repeated until the encryption apparatus 113 outputs partially encrypted AV data to the decryption apparatus 117 which thereupon determines that the partially encrypted AV data has indeed been input.

If in step S31 partially encrypted AV data is found input from the encryption apparatus 113, then step S32 is reached. In step S32, the conversion unit 141 decrypts the partially encrypted AV data using the AES and sends the decrypted AV data to the selection unit 143.

In step S33, the delay unit 142 delays the partially encrypted AV data coming from the encryption apparatus 113 in such a manner as to ensure synchronism with the decrypted AV data output from the conversion unit 141, and supplies the delayed undecrypted AV data to the selection unit 143.

In step S34, the selection unit 143 selects either the decrypted AV data coming from the conversion unit 141 or the undecrypted AV data from the delay unit 142 on the basis of the key signal 151D that has been input, the decrypted and the undecrypted AV data been admitted synchronously. More specifically, if the key signal 151a (in FIG. 9) was input to the selection unit 133 of the encryption apparatus 113, then the same key signal 151a is also input to the selection unit 143. In that case, the selection unit 143 selects the decrypted AV data for the display regions designated by the black area of the key signal 151a while choosing the undecrypted AV data for the display regions specified by the white area of the same signal.

In step S35, the selection unit 143 sends the partially decrypted AV data formed by the decrypted and the undecrypted AV data following the selection to the reception site monitor 118.

In step S36, the conversion unit 141 checks to determine whether the partially encrypted AV data input from the encryption apparatus 113 is terminated.

If in step S36 the partially encrypted AV data coming from the encryption apparatus 113 is not found to be terminated, then step S32 is reached again and steps S32 through S36 are repeated. That is, steps S32 through S36 are repeated until the partially encrypted AV data input from the encryption apparatus 113 is found terminated in step S36.

If in step S36 the partially encrypted AV data coming from the encryption apparatus 113 is found to have ended, then the decryption apparatus 117 terminates its partial decryption process; there is no more partially encrypted AV data out of the encryption apparatus 113 that needs to be partially decrypted.

As described, the decryption apparatus 117 partially decrypts the partially encrypted AV data coming from the encryption apparatus 113 and outputs the partially decrypted AV data.

In the above example, the encryption apparatus 113 was shown to encrypt AV data from the image output apparatus 111 using the key signal 151a, and the decryption apparatus 117 was shown to decrypt the partially encrypted AV data from the encryption apparatus 113 using the same key signal 151a. As a result, the reception site monitor 118 illustratively displays an entire color bar all over its screen as indicated in the left-hand side picture of FIG. 3.

The encryption and decryption system 101 thus encrypts and decrypts only those image areas of the baseband digital video signal which are designated by the key signal 151. This enables the repeater site monitor 115 without the decryption key to display part of the unencrypted image on its screen.

When an image that is partially disclosed so that its outline can be recognizable is used as a specimen prior to full-fledged distribution, the partially encrypted part may later be decrypted by use of a subsequently distributed decryption key and the key signal 151. Where an HD-SDI signal is partially encrypted to maintain its confidentiality, it is possible to keep in balance the confidentiality of the image based on that HD-SDI signal and the tolerable degree of its disclosure, as opposed to the case where the entire image is encrypted just to ensure confidentiality.

The series of steps and processes described above may be executed either by hardware or by software. For the software-based processing to take place, the programs constituting the software may be either incorporated beforehand in dedicated hardware of a computer for program execution or installed upon use into a general-purpose personal computer or like equipment capable of executing diverse functions based on the installed programs.

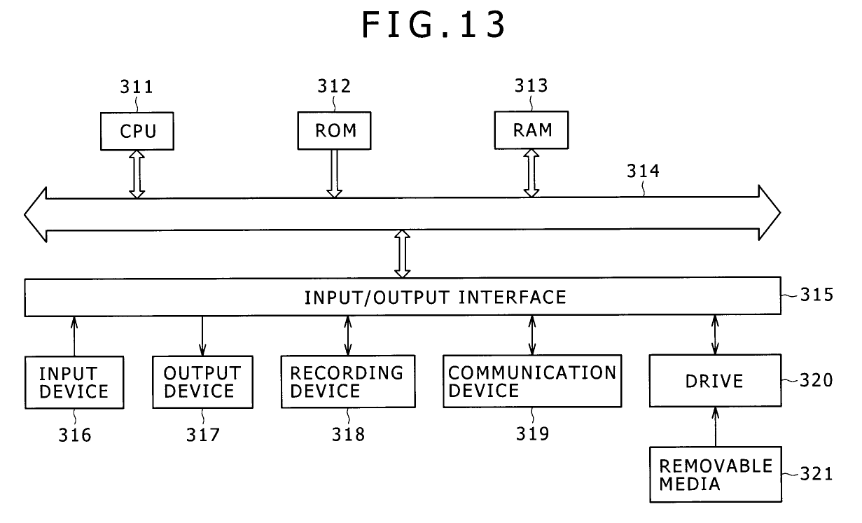

FIG. 13 is a block diagram showing a typical structure of a personal computer that executes in program form the above-described steps and processes according to the embodiment of the present invention. A CPU (Central Processing Unit) 311 performs diverse processes in accordance with suitable programs stored in a ROM (Read Only Memory) 312 or in a recording device 318. A RAM (Random Access Memory) 313 accommodates the programs or data to be executed or operated on by the CPU 311 as necessary. The CPU 311, ROM 312, and RAM 313 are interconnected by a bus 314.

The CPU 311 is also connected with an input/output interface 315 via the bus 314. The input/output interface 315 is connected with an input device 316 made of microphones and with an output device 317 composed of a display and speakers. In operation, the CPU 311 carries out diverse processes in response to commands that are input through the input device 316. The result of the processing is output from the CPU 311 to the output device 317.

The recording device 318 connected to the input/output interface 315 is illustratively constituted by a hard disk drive that records the programs and data performed and operated on by the CPU 311. A communication device 319 communicates with external equipment via the network such as the Internet or a local area network.

Alternatively, programs may be acquired through the communication device 319 and recorded to the recording device 318.

A drive 320 connected to the input/output interface 315 is loaded with removable media 321 such as a magnetic disk, an optical disk, a magneto-optical disk, or a semiconductor memory. When thus loaded with any of these removable media 321, the drive 321 drives the loaded medium and retrieves programs or data therefrom. The programs and data thus acquired are transferred as necessary to the recording device 318 for storage.

As shown in FIG. 13, the program recording media for accommodating computer-installable, computer-executable programs designed to perform the above-described processes are constituted either by the removable media 321 provided as package media such as magnetic disks (including flexible disks), optical disks (including CD-ROM (Compact Disc Read-Only Memory) and DVD (Digital Versatile Disc)), magneto-optical disks, or a semiconductor memory; or by the ROM 312 and a hard disk drive making up the recording device 318 having the programs stored thereon temporarily or permanently. The programs may be recorded to the recording media via the communication device 319 such as a router or a modem by way of wired or wireless communication media such as local area networks, the Internet, or digital satellite broadcasting networks.

In this specification, the steps stored on the program recording medium represent not only the processes that are to be carried out in the depicted sequence (i.e., on a time series basis) but also processes that may be performed parallelly or individually and not chronologically.

In this specification, the term “system” refers to an entire configuration made up of a plurality of component devices.

It should be understood by those skilled in the art that various modifications, combinations, sub-combinations, and alterations may occur depending on design requirements and other factor in so far as they are within the scope of the appended claims or the equivalents thereof.

What is claimed is:

1. An information processing apparatus for converting a first signal furnished as an input baseband video signal into a second signal to be output, said information processing apparatus comprising:
a conversion unit configured to convert said first signal into said second signal of a predetermined system;
a delay unit configured to delay said first signal to ensure synchronism with said second signal following the conversion; and
a selection unit configured to select either the delayed first signal or said second signal in accordance with a third signal;
wherein said selection unit outputs either said delayed first signal or said second signal that has been selected.

2. The information processing apparatus according to claim 1, wherein said conversion unit encrypts said first signal for conversion into said second signal.

3. The information processing apparatus according to claim 2, wherein said conversion involving the encryption is based on the Advanced Encryption Standard known as the AES.

4. The information processing apparatus according to claim 1, wherein said conversion unit decrypts said first signal for conversion into said second signal.

5. The information processing apparatus according to claim 4, wherein said conversion involving the decryption is based on the Advanced Encryption Standard known as the AES.

6. The information processing apparatus according to claim 1, wherein said first signal is a video signal based on a standard known as HD-SDI which stands for the High Definition Serial Digital Interface.

7. The information processing apparatus according to claim 1, wherein said third signal is provided in such a manner that said first signal is selected for an area of each of frames constituting an image corresponding to said first signal and that said second signal is selected for another area of each of the frames making up said image.

8. An information processing method for use with an information processing apparatus for converting a first signal furnished as an input baseband video signal into a second signal to be output, said information processing method comprising the steps of:
converting said first signal into said second signal of a predetermined system;
delaying said first signal to ensure synchronism with said second signal following the conversion; and
selecting either the delayed first signal or said second signal in accordance with a third signal;
wherein said selecting step outputs either said delayed first signal or said second signal that has been selected.

9. A program for use with a computer of an information processing apparatus for converting a first signal furnished as an input baseband video signal into a second signal to be output, said program causing said computer to execute a procedure comprising the steps of:
converting said first signal into said second signal of a predetermined system;
delaying said first signal to ensure synchronism with said second signal following the conversion; and
selecting either the delayed first signal or said second signal in accordance with a third signal;
wherein said selecting step outputs either said delayed first signal or said second signal that has been selected.
